(19) United States
(12) Patent Application Publication
(10) Pub. No.: US 2008/0166964 A1
(43) Pub. Date: Jul. 10, 2008

(54) Wireless transmission arrangement

(75) Inventor: Pei-Chung Liu, Taipei Hsien (TW)

Correspondence Address: BIRCH STEWART KOLASCH & BIRCH, PO BOX 747, FALLS CHURCH, VA, 22040-0747, US

(73) Assignee: Magic Control Technology Corporation

(21) Appl. No.: 11/651,466

(22) Filed: Jan. 10, 2007

(51) Int. Cl. H04H 40/18

(52) U.S. Cl. 455/3.06

(57) ABSTRACT

A wireless transmission arrangement includes the steps of: using a wireless transmission device between an external host and an external monitor to receive a wireless signal from the external host, decoding the wireless signal and converting the decoded wireless signal into a monitor readable signal by means of a processing unit of the wireless transmission device, transmitting the monitor readable signal to the monitor wirelessly by means of the wireless transmission device, and the monitor receiving the monitor readable signal by means of a wireless transmission unit thereof and then displaying the signal.

### BACKGROUND OF THE INVENTION

1. Field of the Invention

The present invention relates to wireless transmission technology and more particularly, to a wireless transmission arrangement, which uses a wireless transmission device to transmit signals wirelessly from a host to a monitor for display.

2. Description of the Related Art

Following fast development of high technology, personal computer has become one of the requisite appliances in every family and office.

People may use a computer to handle different things for different purposes. Advanced computers provided versatile functions. Nowadays, multimedia computers have become very popular. A multimedia computer may be used for inputting, editing, and/or playing AV data. Further, in addition to a mouse, a keyboard, a display screen, and speakers, a computer may be further equipped with other peripheral apparatus such as printer, scanner, webcam, card reader, etc. Following fast cost down, everybody can afford these computer peripheral apparatus.

However, when many peripheral apparatus (mouse, keyboard, display screen, speaker, printer, scanner, webcam, card reader, etc) are used, the connection between the host computer and the peripheral apparatus becomes complicated. Because of the limitation of cables, the peripheral apparatus of a computer system cannot be placed at a far place from the host computer. However, it is difficult to keep all connection cables between the host computer and the peripheral apparatus in a good order. These cables may be tangled or stretched accidentally. Further, when connecting a monitor or other peripheral apparatus to a host computer, the interface matching must be well checked.

FIG. 6 shows the connection arrangement between a host computer B and a monitor C according to the prior art. As illustrated, an USB-to-VGA adapter A is connected between the host computer B and the monitor C. The USB-to-VGA adapter A comprises a USB controller A1 connected to a USB port B1 of the host computer B, a VGA controller A3 connected to the monitor C, and a bridge A2 connected between the USB controller A1 and the VGA controller A3 for converting USB format into VGA format.

The aforesaid USB-to-VGA adapter A is capable of converting USB format into VGA format so that the monitor C can display signals from the host computer B. However, this wired connection method still has drawbacks. The USB-to-VGA adapter A is connectable only between a host computer having a USB interface and a monitor having a VGA interface. If the host computer does not provide a USB interface or the monitor does not provide a VGA interface, the USB-to-VGA adapter A becomes unworkable.

Therefore, it is desirable to provide a connection method between a host computer and a monitor that eliminates the aforesaid drawbacks.

### SUMMARY OF THE INVENTION

The present invention has been accomplished under the circumstances in view. According to one aspect of the present invention, the wireless transmission arrangement is to use a wireless transmission device between an external host and an external monitor to receive a wireless signal from the external host, to decode the wireless signal and convert the decoded wireless signal into a monitor readable signal by means of a processing unit of the wireless transmission device, to transmit the monitor readable signal to the monitor wirelessly by means of the wireless transmission device, and to let the monitor receive the monitor readable signal by means of a wireless transmission unit thereof and then display the signal.

According to another aspect of the present invention, the wireless transmission device further comprises an expansion unit, which comprises a bus control interface for the connection of a matching bus control interface of an external electronic device such as mouse, keyboard, printer, PDA, memory stick, notebook computer, etc.

### BRIEF DESCRIPTION OF THE DRAWINGS

FIG. 1 is a system block diagram of a first embodiment of the present invention.

FIG. 2 is an operation flow of the present invention.

FIG. 3 is a system block diagram of a second embodiment of the present invention.

FIG. 4 is a system block diagram of a third embodiment of the present invention.

FIG. 5 is a system block diagram of a fourth embodiment of the present invention.

FIG. 6 is a system block diagram according to the prior art.

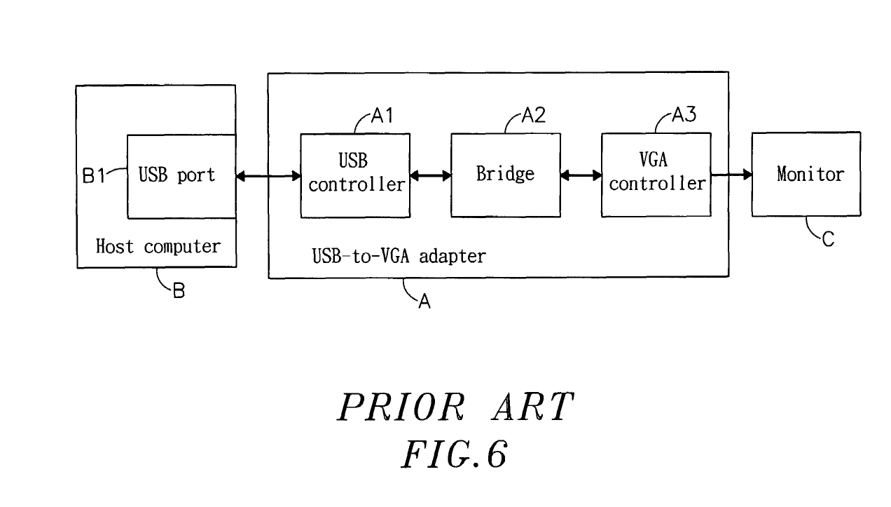

### DETAILED DESCRIPTION OF THE PREFERRED EMBODIMENT

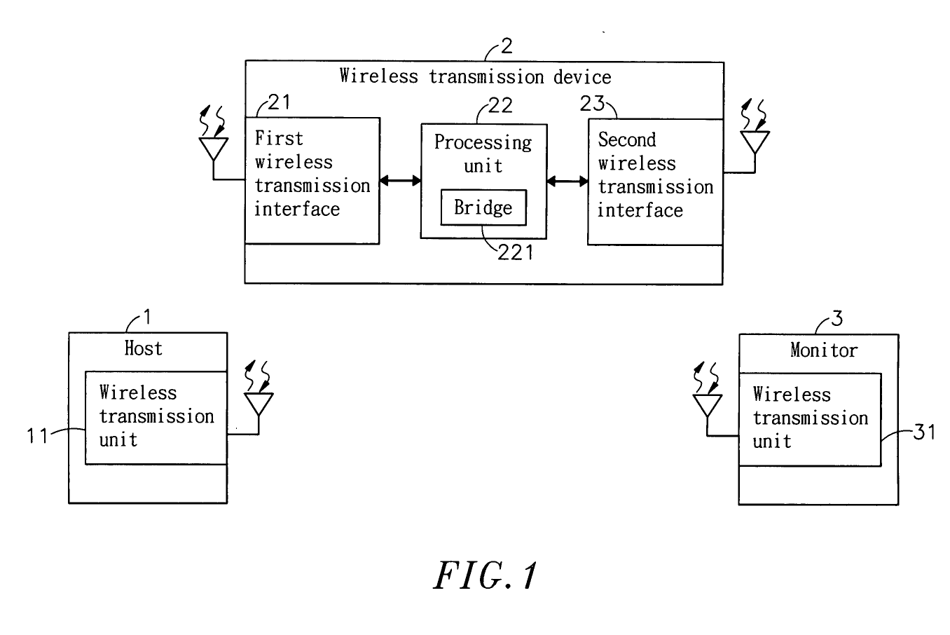

Referring to FIG. 1, a wireless transmission device 2 is provided for communication between a host 1 and a monitor 3 wirelessly. The host 1 has a wireless transmission unit 11 for transmitting/receiving signal wirelessly. The monitor 3 has a wireless transmission unit 31 for transmitting/receiving signal wirelessly. The wireless transmission device 2 receives signal from the host 1, and transmits signal to the monitor 3. The wireless transmission device 2 has a processing unit 22, which decodes signal received from the host 1, and converts the signal into a signal readable to the monitor 3. The signal that is readable to the monitor 3 is then transmitted by wireless transmission device 2 to the wireless transmission unit 31 of the monitor 3 wirelessly for display by the monitor 3.

The wireless transmission device 2 has built therein a first wireless transmission interface 21 at one side and a second wireless transmission interface 22 at the other side. The first wireless transmission interface 21 is adapted to receive signal from the wireless transmission unit 11 of the host 1 wirelessly, and to send the received signal to the processing unit 22, which uses an internal bridge 221 to decode the signal and to convert the decoded signal into a signal readable to the monitor 3. The second wireless transmission interface 22 transmits the monitor readable signal from the bridge 221 to the wireless transmission unit 31 of the monitor 3 for display.

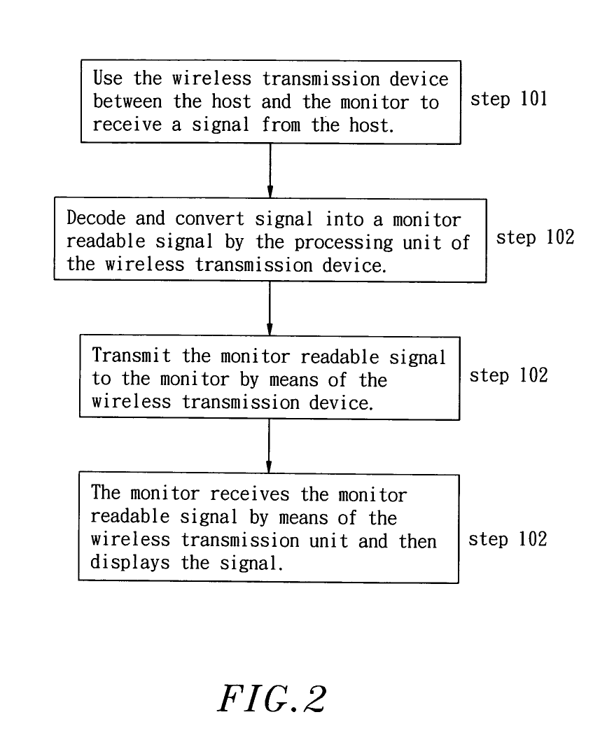

Referring to FIG. 2, the operation flow of the wireless transmission device according to the present invention comprises the steps of:
(101) Use a wireless transmission device between an external host and an external monitor to receive signal from the external host;
(102) Decode the received signal and convert the decoded signal into a monitor readable signal by means of a processing unit of the wireless transmission device;
(103) Transmit the monitor readable signal to the monitor by means of the wireless transmission device;
(104) The monitor receives the monitor readable signal by means of a wireless transmission unit thereof and then displays the signal.

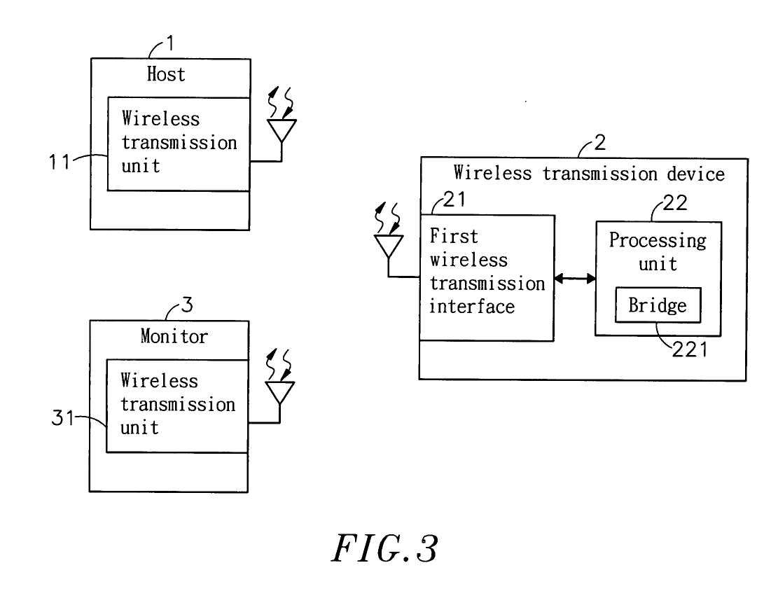

FIG. 3 is a block diagram of a second embodiment of the present invention. According to this embodiment, the wireless transmission device 2 has only one wireless transmission interface 21, which receives a wireless signal from the wireless transmission unit 11 of the host 1 and sends the signal to the processing unit 22 for processing by the bridge 221. After the signal has been decoded and converted into a monitor readable signal, the bridge 221 sends the monitor readable signal to the wireless transmission interface 21, and then the wireless transmission interface 21 transmits the monitor readable signal to the wireless transmission unit 31 of the monitor 3 for display

Further, the aforesaid processing unit 22 controls the wireless transmission interfaces 21 and 23 and the bridge 221 to achieve respective function. After the bridge 221 has decoded the received signal and converted it into a monitor readable signal, the processing unit 22 controls the second wireless transmission interface 23 to transmit the monitor readable signal to the wireless transmission unit 31 of the monitor 3, for enabling the monitor 3 to display the signal from the host 1. Therefore, when the host 1 is equipped with a display card, the wireless transmission unit 11 can transmit a signal of the display card to the monitor 3 for display, i.e., the wireless transmission device 2 works to transmit/receive signal between the host 1 and the monitor 3, thus omitting wired connection between the host 1 and the monitor 3 and eliminating limitation of conventional connection interface means and other transmission problems such as SUB or VGA interface matching problem.

Further, the aforesaid monitor 3 can be a VGA monitor, PCI monitor or AGP monitor.

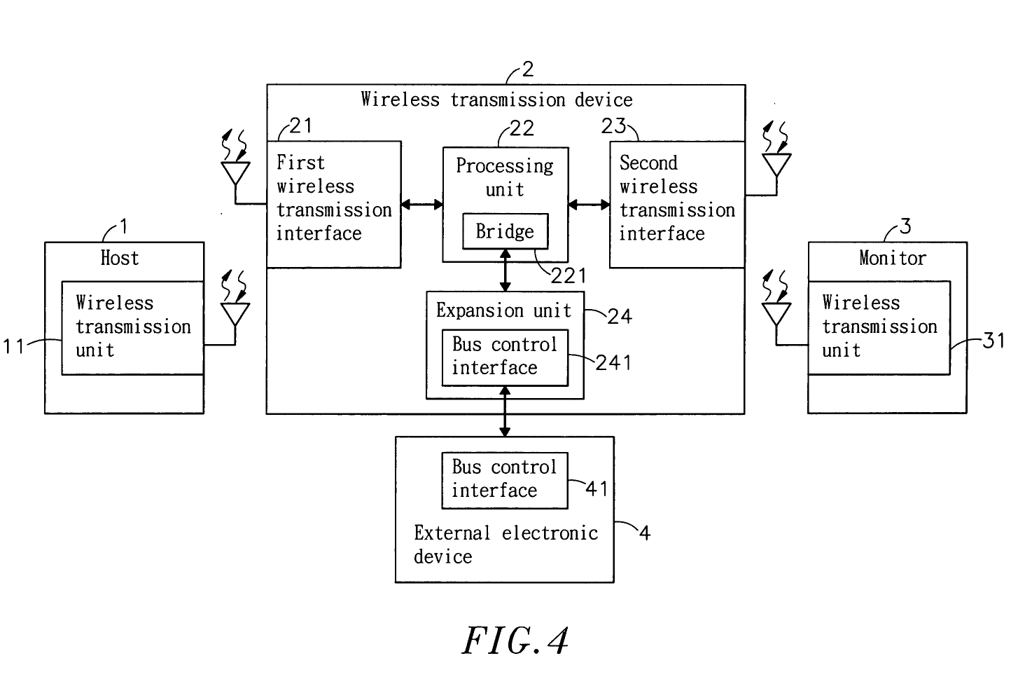

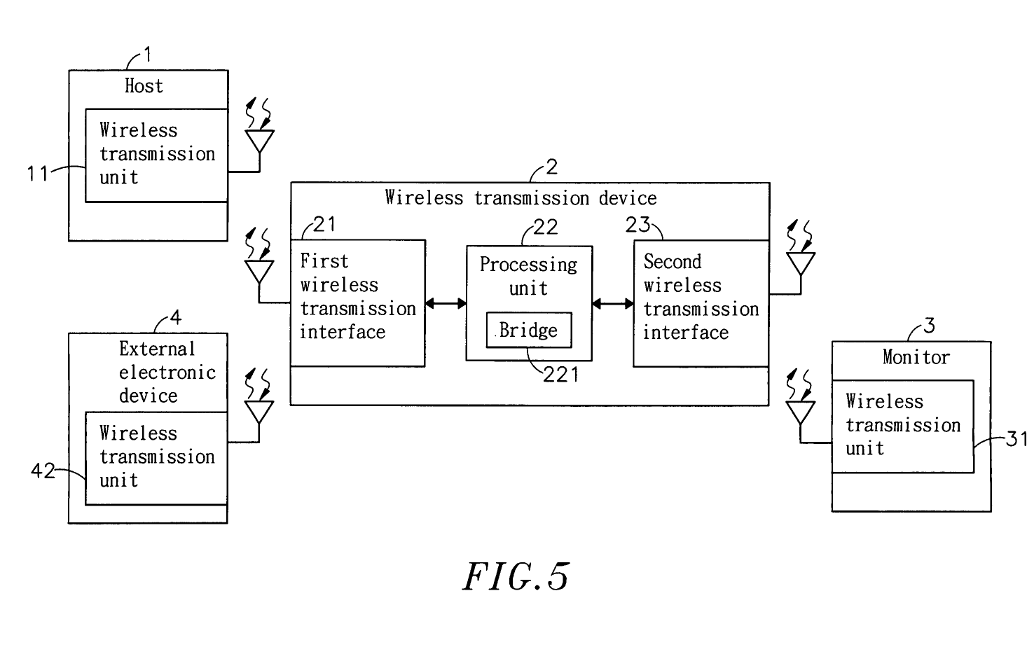

FIGS. 4 and 5 are block diagrams of a third embodiment and a fourth embodiment of the present invention. As illustrated, the wireless transmission device 2 further comprises an expansion unit 24. The expansion unit 24 has a bus control interface 241 for wired connection of an external electronic device 4 (mouse, keyboard, printer, PDA, memory plug, notebook computer, etc.) that has a bus control interface 41 (USB, VGA or any of a variety of other bus control interfaces). The electronic device 4 may be equipped with a wireless transmission unit 42 for transmitting a signal to the wireless transmission interface 21 of the wireless transmission device 2 wirelessly. After processed through the processing unit 22, the wireless transmission device 2 transmits the processed signal to the monitor 3 for display. Therefore, signal transmission between the electronic device 4 and the wireless transmission device 2 can be done in a wired manner or wirelessly.

When the aforesaid expansion unit 24 or wireless transmission interface 21 receives a wired or wireless signal from the electronic device 4, the signal is sent to the processing unit 22, and then decoded and converted into a monitor readable signal by the processing unit 22, and then the wireless transmission interface 23 transmits the monitor readable signal to the monitor 3 for display. When a user wishes to store a signal from the electronic device 4, the host 1 fetches the signal from the electronic device 4 through the wireless transmission device 2, enabling the electronic device 4 to send the signal through the bus control interface 41 or the wireless transmission unit 42 to the expansion unit 24 or the wireless transmission interface 21 of the wireless transmission device 2, and the signal is then processed by the processing unit 22 into a host readable signal, which is then transmitted wirelessly by the wireless transmission interface 21 to the wireless transmission unit 11 of the host 1 for storing in the host 1.

Further, the bus control interface 41 or the wireless transmission unit 42 of the electronic device 4 enables the electronic device 4 to transmit a signal to the wireless transmission device 2 for processing into a monitor readable or host readable signal for further transmission by the wireless transmission device 2 to the monitor 3 or the host 1 wirelessly. The electronic device 4 can also obtain a signal from the host 1 through the wireless transmission device 2. In this case, the processing unit 22 processes the signal received from the host 1 into an electronic device readable signal, and then the wireless transmission interface 21 or the expansion unit 24 transmits the electronic device readable signal to the wireless transmission unit 42 or the bus control interface 41 of the electronic device 4. Thus, the electronic device 4 can receive and store the signal from the host 1.

The aforesaid wireless transmission/receiving method can be achieved by means of bluetooth, infrared, radio frequency or any of a variety of other wireless transmission techniques. By means of the functioning of the wireless transmission device 2, the user can place the monitor 3 on any location within the effective range of the wireless transmission device 2 for displaying signals from the host 1.

As stated above, the host 1 is equipped with a wireless transmission unit 11 capable of transmitting a signal to the wireless transmission interface 21 of the wireless transmission device 2 wirelessly. Upon receipt of a wireless signal, the wireless transmission interface 21 sends the wireless signal to the processing unit 22 for processing into a monitor readable signal for enabling the monitor readable signal to be further transmitted by the wireless transmission interface 23 to the wireless transmission unit 31 of the monitor 3 so that the monitor 3 can display the signal of the host 1. The use of the wireless transmission device 2 eliminates the limitations and drawbacks resulted from a wired connection between the host 1 and the monitor 3.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A wireless transmission arrangement comprising the steps of:
(a) using a wireless transmission device between an external host and an external monitor to receive a wireless signal from said external host;
(b) decoding said wireless signal and converting the decoded wireless signal into a monitor readable signal by means of a processing unit of said wireless transmission device;
(c) transmitting said monitor readable signal to said monitor wirelessly by means of said wireless transmission device;
(d) said monitor receiving said monitor readable signal by means of a wireless transmission unit thereof and then displaying the signal.

2. The wireless transmission arrangement as claimed in claim 1, wherein said wireless transmission device has wireless transmission interface means for receiving said wireless signal from said host and sending the wireless signal to said processing unit for decoding and converting into said monitor readable signal, and transmitting said monitor readable signal to the wireless transmission unit of said monitor.

3. The wireless transmission arrangement as claimed in claim 2, wherein said wireless transmission interface means of said wireless transmission device comprises a first wireless transmission interface adapted to receive said wireless signal from said host and to send the received wireless signal to said processing unit for processing, and a second wireless transmission interface adapted to transmit said monitor readable signal to the wireless transmission unit of said monitor wirelessly.

4. The wireless transmission arrangement as claimed in claim 2, wherein said wireless transmission interface means of said wireless transmission device is constructed subject to one of bluetooth, infrared and radio frequency transmission technology.

5. The wireless transmission arrangement as claimed in claim 1, wherein said wireless transmission device further comprises an expansion unit, said expansion unit comprising a bus control interface for the connection of a matching bus control interface of an external electronic device.

6. The wireless transmission arrangement as claimed in claim 5, wherein said electronic device has a wireless transmission unit for communication with the wireless transmission interface means of said wireless transmission device wirelessly.

7. The wireless transmission arrangement as claimed in claim 1, wherein said monitor is constructed subject to one of VAG, PCI and AGP technologies.
